(19) United States
(12) Patent Application Publication
(10) Pub. No.: US 2021/0107174 A1
(43) Pub. Date: Apr. 15, 2021

(54) Film-cutting device of an environmental coating machine

(71) Applicant: Qianqian Shao, Wenzhou City (CN)

(72) Inventor: Qianqian Shao, Wenzhou City (CN)

(21) Appl. No.: 17/129,946

(22) Filed: Dec. 22, 2020

(30) Foreign Application Priority Data
Dec. 24, 2019 (CN) 2019113516374

(51) Int. Cl. B26D 1/02; B26D 3/16; B26D 7/02

(52) U.S. Cl. CPC B26D 1/025; B26D 7/025; B26D 3/16

(57) ABSTRACT

The invention discloses a film-cutting device of an environmental coating machine, belonging to the technical field of mechanical engineering, which solves the existing problem that the protective film clamped by the conveyor belts are difficult to be cut. The film-cutting device of an environmental coating machine comprises frame (1), several pairs of upper conveyor belts (12) and lower conveyor belts (13), coating areas (15), wherein the film-cutting device comprises a rotation pipe (2), two transmission rods (3), film cutters (32), transverse edges (321), longitudinal edges (331), and a drive member and a spreading element arranged on the frame (1); this film-cutting device of an environmental coating machine is able to but the protective film clamped by the conveyor belts, which can improve an efficiency, reduce the usage amount of the protective film and be more environmental.

### CROSS-REFERENCES TO RELATED APPLICATIONS

The present application claims priority from Chinese application No. 2019113516374 filed on Dec. 24, 2019 which is hereby incorporated by reference in its entirety.

### TECHNICAL FIELD

The present invention relates to the technical field of mechanical devices, in particular to a film-cutting device of an environmental coating machine.

### BACKGROUND OF THE INVENTION

To avoid a surface scratching, many small tubular containers, especially for those ceramics will be coated when they are manufactured. Such a protective film will seal the ports, peripheral surfaces and the under-surface of the tubular work-piece. As the longitudinal section of the peripheral surfaces of the tubular work-piece is usually on arc-shaped, wherein the middle part will arch outwards, that means the outer diameter of two ends of the tubular work-piece is smaller while the outer diameter of the middle part is larger. When coating performs, the protective film is required to be cut into rectangles, which means the larger protective film will be cut along the pulling out direction after pulled from the reel, and then the protective film will be cut horizontally to ensure the protective film to keep a stretched state when coating; the protective film is pulled out in the manner of upper and lower conveyor belts clamping; at this time, when cutting horizontally, as the protective film is clamped by the conveyor belts, so the clamped part is not easy to be cut; if the protective film is cut from the front end of the conveyor belt, and then the protective film on the reel will be separated from the conveyor belt, which requires the operator to clip the protective film between the upper and lower conveyor belts manually, and such a working way will affect the efficiency.

### BRIEF SUMMARY OF THE INVENTION

The technical problem to be solved by the invention is to provide a film-cutting device of an environmental coating machine so as to cut the protective film clamped by the conveyor belts and improve the working efficiency.

The purpose of the present invention is achieved by the following technical schemes: a film-cutting device of an environmental coating machine comprises a frame, the positioning roller for locating the protective film rollers is arranged on the frame, several pairs of upper conveyor belts and lower conveyor belts, and several pairs of the upper conveyor belts and the lower conveyor belts are corresponded with each other, and a lower side surface of each of the upper conveyor belts is pressed against an upper side surface of the lower conveyor belts, wherein the upper conveyor belts and the lower conveyor belts can clamp and pull out the protective film on the positioning roller along a lengthways, and coating areas are formed between two of the upper conveyor belts of the same pair, and the film-cutting machine comprises a rotation pipe arranged horizontally and rotatably connected on the frame, and cutters for cutting the protective film along a pulling direction are arranged between two pairs of the upper conveyor belts by the frame, and the cutters are located between the positioning roller and the rotation pipe, and two of transmission rods are slidably disposed within the rotation pipe along the length direction, wherein several of film cutters located on the rotation pipe are fixed on the transmission rods along the length direction, and several of the film cutters on each of the transmission rods are respectively located within several of the coating areas, and transverse edges are horizontally arranged on the film cutters, and orientations of the transverse edges of two of the film cutters within the same one of the coating areas on the transmission rods are opposite, wherein longitudinal edges are formed when two of the film cutters within the same one of the coating areas are closing to each other, and a drive member for driving the rotation pipe to rotate to make the longitudinal edges on the film cutters to pass through the protective film upward, and a spreading element for driving an opposition part of the upper conveyor belts and the lower conveyor belts to the transverse edges to separate to form film-cutting clearances when the rotation pipe rotates are arranged on the frame; whereby the drive member can drive two of the transmission rods to move along the orientation facing by the transverse edges corresponding one of the transverse edges and make the transverse edges to pass through the film-cutting clearances when the longitudinal edges pass through the protective film.

The protective film roll is located on the positioning roller, wherein one end of the protective film is clamped and pulled out gradually by the upper conveyor belts and the lower conveyor belts, and then the cutters can cut the protective film along the pulling direction, and then the upper conveyor belts and the lower conveyor belts on two sides of the coating areas respectively clamp two edges of the cut protective film, and at this time, the film cutters are located below the protective film, the drive member can drive the rotation pipe to rotate, and the longitudinal edges of the film cutters are driven to insert into and pass through the above protective film, and ejector wheels are driven when the rotation pipe rotates, and then the upper conveyor belts and the lower conveyor belts are driven to ejected by the ejector wheels, and then the opposition part of the upper conveyor belts and the lower conveyor belts to the transverse edges is ejected and separated to form the film-cutting clearances, and then other parts of the upper conveyor belts and the lower conveyor belts are still clamping the protective film to avoid a separation of the ends of the protective film on the protective film roll from the upper conveyor belts and the lower conveyor belts after being cut by the film cutters, and then the drive member will further drive the transmission rods to move asynchronously and reversely after the film cutters pass through the ejector wheels, and then the film cutters in the coating areas will move reversely, that is to say, two of the film cutters move towards the direction of the transverse edges until the film cutters pass through the film-cutting clearances, so that the protective film can be cut off, and then the ends of the protective film on protective film roll will be clamped by the upper conveyor belts and the lower conveyor belts after a separation of the protective film, which is convenient for coating work for next work-piece and improves an efficiency.

Among the above-stated a film-cutting device of an environmental coating machine, wherein a pair of supporting plates are fixed in each of the coating areas on an periphery surface of the rotation pipe, wherein the supporting plates on long strip are arranged horizontally, and cross section of the supporting plates are on arc-shaped and several of the supporting plates have a same center line with the rotation pipe, wherein the supporting plates of the same pair are arranged paralleled, and avoidance clearance are formed between opposite edges of the supporting plates, and avoidance notches are defined on the periphery surface of the rotation pipe along the length direction, and several of connecting rods are fixed on two of the transmission rods, wherein several of the supporting plates pass through the avoidance notches, and the film cutters are fixed on free ends of the connecting rods and the film cutters pass through avoidance clearances and protrude to outer side surfaces of the supporting plates; whereby when the rotation pipe rotate to drive the film cutters to upward vertically, the highest point of the periphery surface of the supporting plates is higher than that of upper side surfaces of the lower conveyor belts, thereby the supporting plates can strain the protective film upward, that is the protective film on tension state sticks on two of the supporting plates; at this time, when two of the transmission rods move, the transverse edges is able to cut the protective film easier than before to avoid a displacement caused by a looseness of the protective film.

Among the above-stated a film-cutting device of an environmental coating machine, wherein the connecting rods comprise radial segments and axial segments, wherein the radial segments is on Z-shaped and one end of each of the radial segments is fixedly and vertically connected with the transmission rods, and another end of each of the radial segments passes through the avoidance notches of the rotation pipe, wherein guide surfaces on arc-shaped are arranged on middle of the radial segments, wherein the guide surfaces stick to an inner circumference of the rotation pipe, and the axial segments is arranged horizontally, and one end of each of the axial segments is fixedly and vertically connected with protruding end of each of the radial segments, and each of the film cutters is fixed on another end of each of the axial segments, and the orientation of another end of each of the axial segments is the same as the orientation of the transverse edges on the film cutters, and each of support portions which is protruding is arranged on another end of each of the axial segments, and the orientation of the transverse edges is the same as a protruding direction of the support portions, wherein the support portions is located within the supporting plates; whereby when the drive member drives the transmission rods to move, the axial segments is able to extend into the film-cutting clearances, and the guide surfaces are slidably coupled to the inner circumference of the rotation pipe to make the film cutters more stable, and when the film cutters are abutted against each other, the radial segments of two of the connecting rods are in a separation state, and when two of the transmission rods move in opposite direction, two of the radial segments close to each other first and then continue to move for separation after stick to each other, and an arrangement of the axial segments is convenient for the film cutters to extend into the film-cutting clearances.

Among the above-stated a film-cutting device of an environmental coating machine, wherein the film cutters are on long strip, and one edge of each of the film cutters is a corresponding one of the transverse edges, and blades are arranged on side edges of the film cutters, wherein the blades are vertical to side surfaces of the film cutters, and upper parts of the blades are bulging at a sharp angle away from the film cutters, and the edges of the blades away from the film cutters are on arc-shaped and the distance of the edge of arcs to the film cutters are getting smaller from top to bottom; whereby when another edge of each of two of the film cutters within the coating areas of the same one is abutted against each other, side surfaces of two of the blades are sticking to each other, and the longitudinal edges are formed by edge sticking of the arcs on two of the blades, and guide portions on plate shaped are vertically arranged on upper parts of the side surfaces of the film cutters, wherein the guide portions are fixedly connected with upper side surfaces of the blades, wherein guide rims is arranged in the guide portions, wherein one end of each of the guide rims extends into sharp corners of the blades and another end of each of the guide rims extends into each of the transverse edges on corresponding one of the film cutters; whereby when edges of two of the film cutters are abutted against each other, two of the blades are sticking to each other and form the longitudinal edges, and when the rotation pipe rotates, the sharp corners of the blades is able to insert into and pass through the protective film under an action of the longitudinal edges, and then the guide rims can push away the protective film from two sides until the film cutters pass through the protective film, which can avoid the film cutters hooking the protective film.

Among the above-stated a film-cutting device of an environmental coating machine, wherein the driving member comprises a driven air cylinder, a driven rod is slidably and horizontally connected on the frame, wherein a piston rod of the driven air cylinder is fixedly connected with one end of the driven rod, wherein two of push pins which are protrudes along a radial direction are arranged on outer circumference end of another end of the driven rod, wherein two of the push pins are arranged with a same axis, and two of transmission grooves on long strip are defined on side walls of one end of the rotation pipe along the axis, and the transmission grooves are spirally arranged along a circumference of the rotation shaft, wherein two of the transmission grooves are symmetrically arranged relative to the center line of the rotation pipe, and another end of the driven rod extends into the rotation pipe, and two of the push pins are slidably and respectively inserted between two of the transmission grooves; whereby when the push pins are located on outer ends of the transmission grooves, the film cutters is inclined and in an upward arrangement, and when the driven rod drive the push pins to slide to inner ends of the transmission grooves, the rotation pipe rotate until the film cutters is vertically upward, and then the driven air cylinder drives the driven rod, and the push pins on the driven rod are able to eject the groove walls of the transmission grooves to drive the rotation pipe to rotate, and then the film cutters is swing upward to pass through the protective film.

Among the above-stated a film-cutting device of an environmental coating machine, wherein an ejection rod is fixed on another end of the driven rod along the axial direction, wherein ends of the ejection rod are opposite to one end of one of the transmission rods, wherein resetting springs are arranged between another end of the one of the transmission rods and the rotation pipe, wherein two of guiding grooves which are arranged along the axial direction are defined on side walls of the rotation pipe, and two of the guiding grooves are arranged symmetrically and outer ends of the guiding grooves are communicated with inner ends of two of the transmission grooves; whereby when the film cutters are vertically upward, the push pins is able to slide into the guiding grooves, and another end of the ejection rod is abutted against the end of one of the transmission rods, and transmission gears for driving another one of the transmission rods to slide reversely and synchronously when one of the transmission rods slides are arranged in the rotation pipe; whereby when the push pins ejects the groove walls of the transmission grooves to drive the rotation pipe to rotate, a clearance is formed between the ejection rod and the transmission rods, and the rotation pipe turn into place when the push pins slide into the guiding grooves, at this time, the ejection rod is opposite to and abutted against the end of one of the transmission rods, and with a further ejection of the driven air cylinder to the driven rod, the ejection rod is able to eject the transmission rods to move, and then the push pins slide along the guiding grooves; when the piston rod of the driven air cylinder contracts to reset, the resetting springs is able to drive the transmission rods to move to reset.

Among the above-stated a film-cutting device of an environmental coating machine, wherein two pairs of limiting ledges which are arranged along the axial direction are arranged on the inner circumference of the rotation pipe, wherein side surfaces of same one pair of the limiting ledges are vertical to each other, and the outer side surfaces of the transmission rods comprise one cambered surface and two flat surfaces, wherein the transmission rods are slidably arranged between same one pair of the limiting ledges, and the cambered surfaces of the transmission rods come into contact with the inner circumference of the rotation pipe, and two flat surfaces of the transmission rods respectively come into contact with side surfaces of two of the limiting ledges of the same pair, and clearances are formed between two of the transmission rods, and avoidance recessed shoulders which are arranged on opposite side surfaces of two of the transmission rods along the length direction, and connecting columns is fixed in the rotation pipe along the radial direction, wherein the connecting columns are located between the clearances of two of the transmission rods, wherein the transmission gears are rotatably disposed on top ends of the connecting columns, and transmission racks are fixedly disposed within the avoidance recessed shoulders of two of the transmission rods along the length direction, wherein the transmission gears are engaged with two of the transmission racks, and the transmission rods are slidably coupled to the rotation pipe with several surfaces, which has a high stability and ensure the stability of the film cutters; two of the transmission rods moves reversely and synchronously through the transmission gears with a compact and stable structure.

Among the above-stated a film-cutting device of an environmental coating machine, wherein the spreading element comprises the ejector wheels, and upper ejection flangings are arranged on outer sides of the upper conveyor belts along the circumference, lower ejection flangings are arranged on outer sides of the lower conveyor belts along the circumference, wherein ejection clearances are formed between the upper ejection flangings and the lower ejection flangings, and the transmission pins are rotatably connected on outer sides of the ejection clearances by the frame, wherein the transmission pins are rotatably connected on the struts, and the transmission pins are arranged along the horizontal direction, wherein each of the supporting rods are vertically fixed on one end of each of the ejection clearances of the transmission pins, wherein the ejector wheels are rotatably connected with two ends of the supporting rods, and the ejector wheels on two ends of the swing rods are symmetrically arranged with the transmission pins, and two of the ejector wheels inserts into the ejection clearances, and two of the ejector wheels are on same one horizontal plane when the film cutters incline upwardly, and pushing rods for driving the transmission pins to rotate when the rotation pipe rotate are arranged on the outer circumference of the rotation pipe; whereby when the upper conveyor belts and the lower conveyor belts pull out the protective film and not begin to cut the protective film, the supporting rods are in a horizontal position, and two of the ejector wheels are located in the ejection clearances, and when the rotation pipe rotates to drive the transmission pins to rotate through the pushing rods, the transmission pins drive the supporting rods to swing, so that a height difference will be formed between two of the ejector wheels, that is to say, two of the ejector wheels are able to eject the upper ejection flangings and the lower ejection flangings respectively to spread the upper conveyor belts and the lower conveyor belts to form the film-cutting clearances, so that the part of the protective film clamped by the upper conveyor belts and the lower conveyor belts can be cut.

Among the above-stated a film-cutting device of an environmental coating machine, wherein the swing rods are fixedly and vertically disposed on the transmission pins, and the swing rods are vertically downward when the supporting rods is on horizontal position, and one end of the pushing rods is vertically connected with ejection columns, wherein the ejection columns is located at a side part of each of the swing rods, and a vertical dimension between a center line of the ejection columns and a center line of the rotation pipe is larger than the vertical dimension between the center line of the ejection columns and a center line of the transmission pins, and the rotation pipe rotate to drive the pushing rods to swing, and then the ejection columns on the pushing rods is able to eject the ejector wheels to drive the transmission pins to rotate.

Among the above-stated a film-cutting device of an environmental coating machine, wherein the frame comprises two rows of struts vertically arranged, wherein upper transfer rollers and lower transfer rollers are rotatably arranged on the struts, wherein the upper conveyor belts are sleeved on corresponding two of the upper transfer rollers and the lower transfer rollers, and the lower conveyor belts are sleeved on corresponding two of the lower transfer rollers, and the upper transfer rollers on same row are fixed connected with each other by an upper rotation shaft, and the lower transfer rollers on same row are fixedly connected with each other by a lower rotation shaft, and the lower transfer rollers are driven to rotate by the driven motor, wherein the transmission pins are rotatably connected on the struts, wherein the cutters on a long strip are vertically and fixedly connected on the struts, and edges of the cutters facing to the positioning roller are cutting edges; whereby the protective film will be cut by the cutters when pulled out from the protective film roll.

Compared with the existing technology, the advantages of the film-cutting device of an environmental coating machine in this invention are listed as follows:

As the drive member will further drive the transmission rods to move asynchronously and reversely after the film cutters pass through the ejector wheels, and then the film cutters in the coating areas will move reversely, that is to say, two of the film cutters move towards the direction of the transverse edges until the film cutters pass through the film-cutting clearances, so that the protective film can be cut off, and then the ends of the protective film on protective film roll will be clamped by the upper conveyor belts and the lower conveyor belts after a separation of the protective film, which is convenient for coating work for next work-piece and improves an efficiency.

1. As a pair of supporting plates are fixed on the rotation pipe, and whereby when the rotation pipe rotate to drive the film cutters to upward vertically, the highest point of the periphery surface of the supporting plates is higher than that of upper side surfaces of the lower conveyor belts, thereby the supporting plates can strain the protective film upward, that is the protective film on tension state sticks on two of the supporting plates; at this time, when two of the transmission rods move, the transverse edges is able to cut the protective film easier than before to avoid a displacement caused by a looseness of the protective film.

2. As pushing rods for driving the transmission pins to rotate when the rotation pipe rotate are arranged on the outer circumference of the rotation pipe; whereby when the upper conveyor belts and the lower conveyor belts pull out the protective film and not begin to cut the protective film, the supporting rods are in a horizontal position, and two of the ejector wheels are located in the ejection clearances, and when the rotation pipe rotates to drive the transmission pins to rotate through the pushing rods, the transmission pins drive the supporting rods to swing, so that a height difference will be formed between two of the ejector wheels, that is to say, two of the ejector wheels are able to eject the upper ejection flangings and the lower ejection flangings respectively to spread the upper conveyor belts and the lower conveyor belts to form the film-cutting clearances, so that the part of the protective film clamped by the upper conveyor belts and the lower conveyor belts can be cut.

### BRIEF DESCRIPTION OF THE DRAWINGS

FIG. 1 is a stereoscopic schematic structural diagram depicting an environmental coating machine.

FIG. 2 is a top view showing construction of an environmental coating machine.

FIG. 3 is the enlarged structural diagram of “A” in FIG. 1.

FIG. 4 is a stereoscopic schematic structural diagram depicting an rotation pipe.

FIG. 5 is a cross-sectional view showing a schematic structural diagram of rotation pipe.

FIG. 6 is the enlarged structural diagram of “B” in FIG. 4.

FIG. 7 is the enlarged structural diagram of “C” in FIG. 5.

FIG. 8 is the partial schematic structural diagram of a film cutter.

FIG. 9 is the enlarged structural diagram of “D” in FIG. 1.

FIG. 10 is the enlarged structural diagram of “E” in FIG. 5.

FIG. 11 is a partial stereoscopic view showing a schematic structural diagram depicting ejector wheels of an environmental coating machine.

FIG. 12 is a partial exploded view showing a structural diagram along “F-F” direction in FIG. 2.

FIG. 13 is a partial exploded view showing a structural diagram of forming a film-cutting clearance in “F-F” position in FIG. 2.

In the figures, a frame 1, a positioning roller 11, upper conveyor belts 12, upper ejection flangings 121, upper transfer rollers 122, lower conveyor belts 13, lower ejection flangings 131, lower transfer rollers 132, ejection clearances 14, coating areas 15, struts 16, a rotation pipe 2, supporting plates 21, avoidance clearances 211, avoidance notches 22, transmission grooves 23, guiding grooves 24, resetting springs 25, connecting columns 26, transmission gears 261, limiting ledges 27, pushing rods 28, ejection columns 281, transmission rods 3, connecting rods 31, radial segments 311, axial segments 312, guide surfaces 313, support portions 314, film cutters 32, transverse edges 321, blades 33, longitudinal edges 331, guide portions 34, guide rims 341, avoidance recessed shoulders 35, transmission racks 36, a driven air cylinder 4, a driven rod 41, push pins 411, an ejection rod 42, transmission pins 5, supporting rods 51, ejector wheels 52, swing rods 53, cutters 6, film-cutting clearances 7.

### DETAILED DESCRIPTION OF THE INVENTION

The technical scheme of the invention is further described by the embodiments of the invention not limiting the scope and spirit of the invention in combination with accompanying figures.

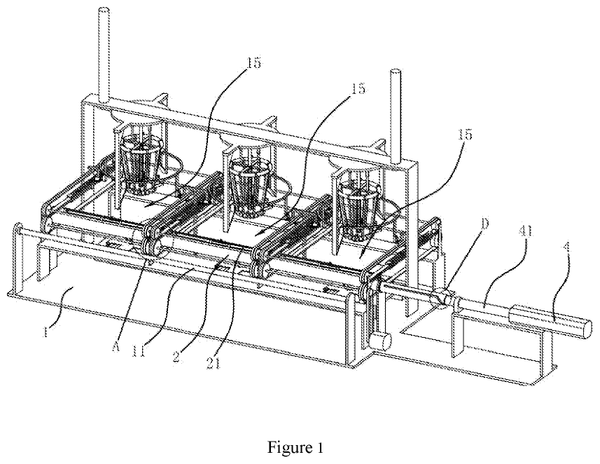

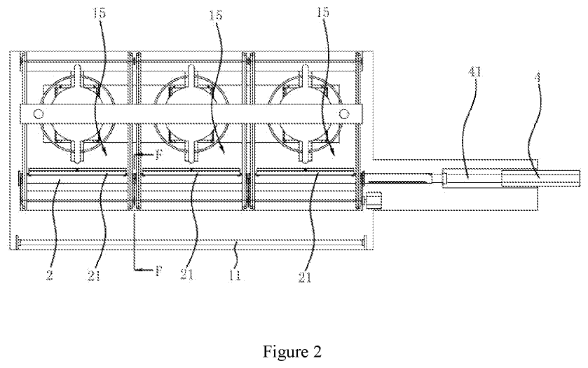

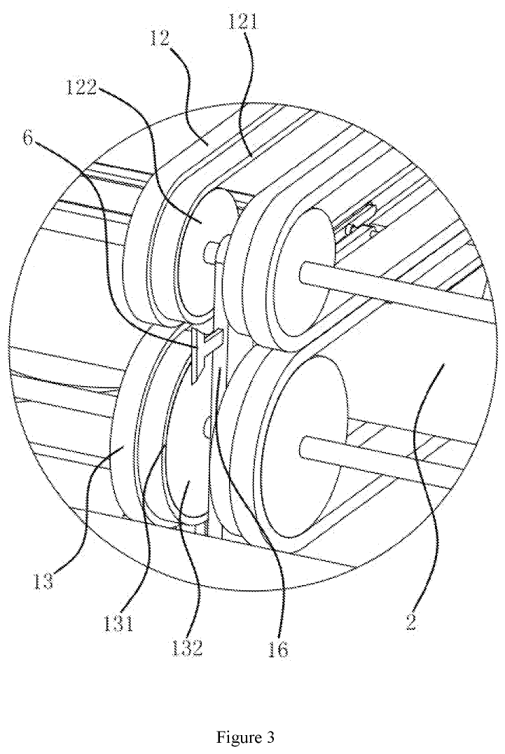

Referring to FIGS. 1, 2 and 3, a film-cutting device of an environmental coating machine comprises a frame 1, the positioning roller 11 for locating the protective film rollers is arranged on the frame 1, several pairs of upper conveyor belts 12 and lower conveyor belts 13, wherein the frame 1 comprises two rows of struts 16 vertically arranged, wherein upper transfer rollers 122 and lower transfer rollers 132 are rotatably arranged on the struts 16, wherein the upper conveyor belts 12 are sleeved on corresponding two of the upper transfer rollers 122 and the lower transfer rollers 132, and the lower conveyor belts 13 are sleeved on corresponding two of the lower transfer rollers 132, and the upper transfer rollers 122 on same row are fixed connected with each other by an upper rotation shaft, and the lower transfer rollers 132 on same row are fixedly connected with each other by a lower rotation shaft, and the lower transfer rollers 132 are driven to rotate by the driven motor, and several pairs of the upper conveyor belts 12 and the lower conveyor belts 13 are corresponded with each other, and a lower side surface of each of the upper conveyor belts 12 is pressed against an upper side surface of the lower conveyor belts 13, wherein the upper conveyor belts 12 and the lower conveyor belts 13 can clamp and pull out the protective film on the positioning roller 11 along a lengthways, and coating areas 15 are formed between two of the upper conveyor belts 12 of the same pair, and the film-cutting machine comprises a rotation pipe 2 arranged horizontally and rotatably connected on the frame 1, and cutters 6 for cutting the protective film along a pulling direction are arranged between two pairs of the upper conveyor belts 12 by the frame 1, and the cutters 6 are located between the positioning roller 11 and the rotation pipe 2, wherein the cutters 6 on a long strip are vertically and fixedly connected on the struts 16, and edges of the cutters 6 facing to the positioning roller 11 are cutting edges, and two of transmission rods 3 are slidably disposed within the rotation pipe 2 along the length direction, wherein several of film cutters 32 located on the rotation pipe 2 are fixed on the transmission rods 3 along the length direction, and several of the film cutters 32 on each of the transmission rods 3 are respectively located within several of the coating areas 15, and transverse edges 321 are horizontally arranged on the film cutters 32, and orientations of the transverse edges 321 of two of the film cutters 32 within the same one of the coating areas 15 on the transmission rods 3 are opposite, wherein longitudinal edges 331 are formed when two of the film cutters 32 within the same one of the coating areas 15 are closing to each other, and a drive member for driving the rotation pipe 2 to rotate to make the longitudinal edges 331 on the film cutters 32 to pass through the protective film upward, and a spreading element for driving an opposition part of the upper conveyor belts 12 and the lower conveyor belts 13 to the transverse edges 321 to separate to form film-cutting clearances 7 when the rotation pipe 2 rotates are arranged on the frame 1; whereby the drive member can drive two of the transmission rods 3 to move along the orientation facing by the transverse edges 321 corresponding one of the transverse edges 321 and make the transverse edges 321 to pass through the film-cutting clearances 7 when the longitudinal edges 331 pass through the protective film, and the protective film roll is located on the positioning roller 11, wherein one end of the protective film is clamped and pulled out gradually by the upper conveyor belts 12 and the lower conveyor belts 13, and then the cutters 6 can cut the protective film along the pulling direction, and then the upper conveyor belts 12 and the lower conveyor belts 13 on two sides of the coating areas 15 respectively clamp two edges of the cut protective film, and at this time, the film cutters 32 are located below the protective film, the drive member can drive the rotation pipe 2 to rotate, and the longitudinal edges 331 of the film cutters 32 are driven to insert into and pass through the above protective film, and ejector wheels 52 are driven when the rotation pipe 2 rotates, and then the upper conveyor belts 12 and the lower conveyor belts 13 are driven to ejected by the ejector wheels 52, and then the opposition part of the upper conveyor belts 12 and the lower conveyor belts 13 to the transverse edges 321 is ejected and separated to form the film-cutting clearances 7, and then other parts of the upper conveyor belts 12 and the lower conveyor belts 13 are still clamping the protective film to avoid a separation of the ends of the protective film on the protective film roll from the upper conveyor belts 12 and the lower conveyor belts 13 after being cut by the film cutters 32, and then the drive member will further drive the transmission rods 3 to move asynchronously and reversely after the film cutters 32 pass through the ejector wheels 52, and then the film cutters 32 in the coating areas 15 will move reversely, that is to say, two of the film cutters 32 move towards the direction of the transverse edges 321 until the film cutters 32 pass through the film-cutting clearances 7, so that the protective film can be cut off, and then the ends of the protective film on protective film roll will be clamped by the upper conveyor belts 12 and the lower conveyor belts 13 after a separation of the protective film, which is convenient for coating work for next work-piece and improves an efficiency.

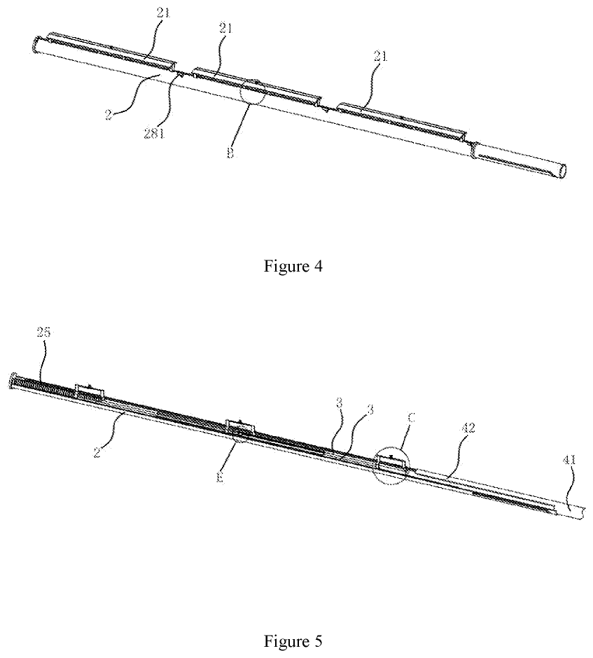

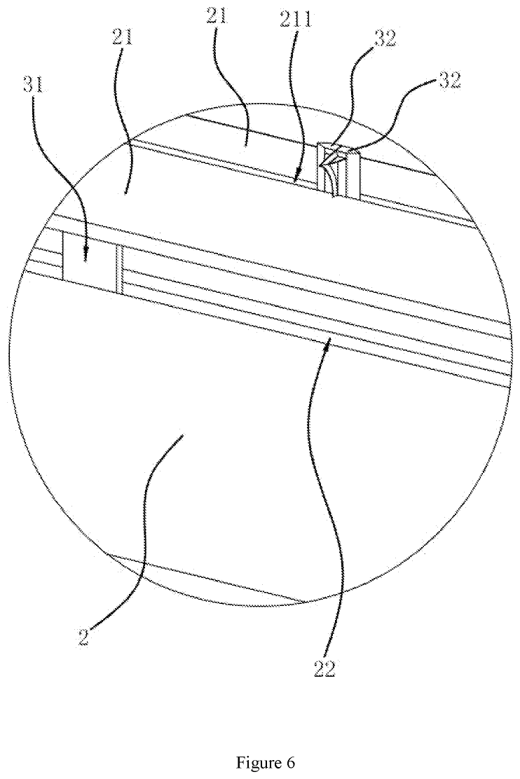

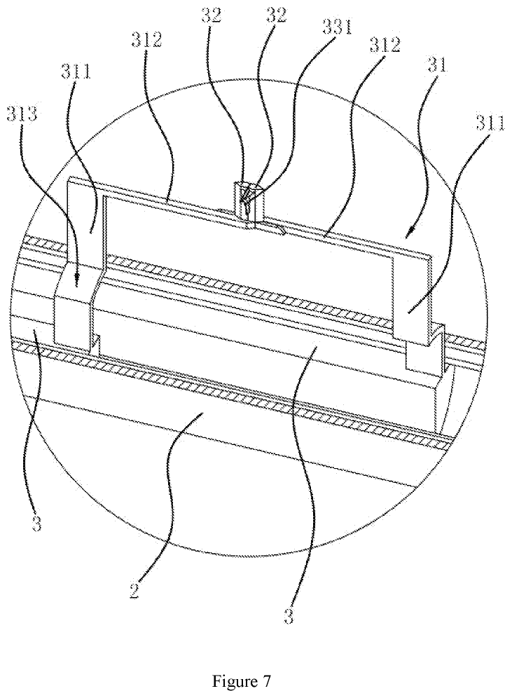

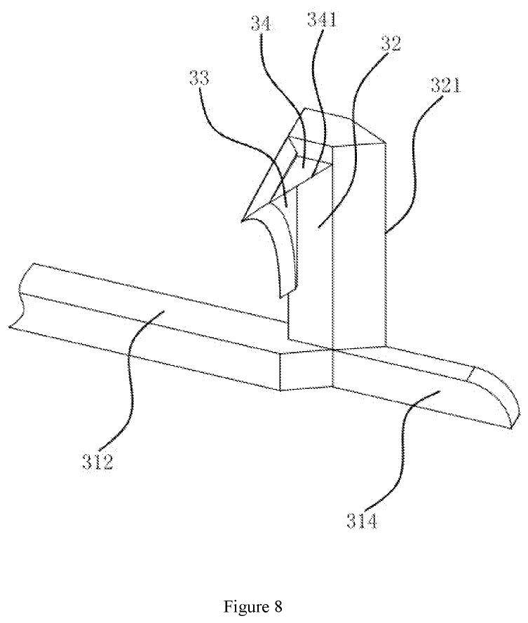

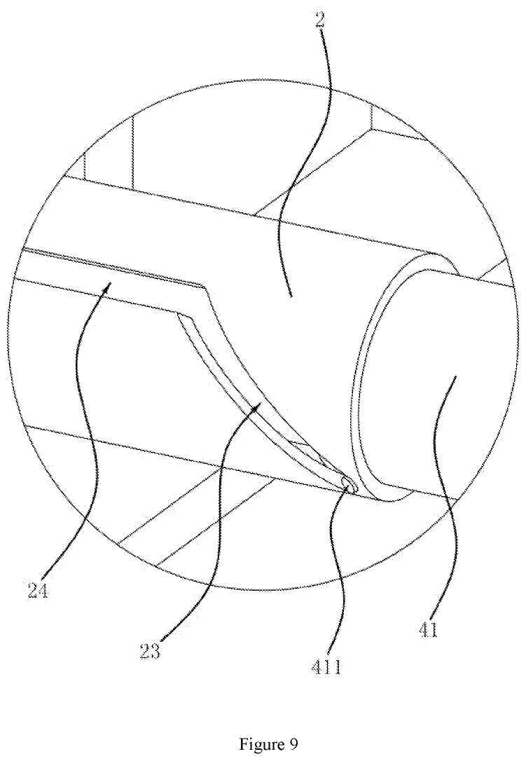

Referring to FIG. 4-8, a pair of supporting plates 21 are fixed in each of the coating areas 15 on an periphery surface of the rotation pipe 2, wherein the supporting plates 21 on long strip are arranged horizontally, and cross section of the supporting plates 21 are on arc-shaped and several of the supporting plates 21 have a same center line with the rotation pipe 2, wherein the supporting plates 21 of the same pair are arranged paralleled, and avoidance clearance 211 are formed between opposite edges of the supporting plates 21, and avoidance notches 22 are defined on the periphery surface of the rotation pipe 2 along the length direction, and several of connecting rods 31 are fixed on two of the transmission rods 3, wherein several of the supporting plates 21 pass through the avoidance notches 22, and the film cutters 32 are fixed on free ends of the connecting rods 31 and the film cutters 32 pass through avoidance clearances 211 and protrude to outer side surfaces of the supporting plates 21; whereby when the rotation pipe 2 rotate to drive the film cutters 32 to upward vertically, the highest point of the periphery surface of the supporting plates 21 is higher than that of upper side surfaces of the lower conveyor belts 13, thereby the supporting plates 21 can strain the protective film upward, that is the protective film on tension state sticks on two of the supporting plates 21; at this time, when two of the transmission rods 3 move, the transverse edges 321 is able to cut the protective film easier than before to avoid a displacement caused by a looseness of the protective film; the connecting rods 31 comprise radial segments 311 and axial segments 312, wherein the radial segments 311 is on Z-shaped and one end of each of the radial segments 311 is fixedly and vertically connected with the transmission rods 3, and another end of each of the radial segments 311 passes through the avoidance notches 22 of the rotation pipe 2, wherein guide surfaces 313 on arc-shaped are arranged on middle of the radial segments 311, wherein the guide surfaces 313 stick to an inner circumference of the rotation pipe 2, and the axial segments 312 is arranged horizontally, and one end of each of the axial segments 312 is fixedly and vertically connected with protruding end of each of the radial segments 311, and each of the film cutters 32 is fixed on another end of each of the axial segments 312, and the orientation of another end of each of the axial segments 312 is the same as the orientation of the transverse edges 321 on the film cutters 32, and each of support portions 314 which is protruding is arranged on another end of each of the axial segments 312, and the orientation of the transverse edges 321 is the same as a protruding direction of the support portions 314, wherein the support portions 314 is located within the supporting plates 21; whereby when the drive member drives the transmission rods 3 to move, the axial segments 312 is able to extend into the film-cutting clearances 7, and the guide surfaces 313 are slidably coupled to the inner circumference of the rotation pipe 2 to make the film cutters 32 more stable, and when the film cutters 32 are abutted against each other, the radial segments 311 of two of the connecting rods 31 are in a separation state, and when two of the transmission rods 3 move in opposite direction, two of the radial segments 311 close to each other first and then continue to move for separation after stick to each other, and an arrangement of the axial segments 312 is convenient for the film cutters 32 to extend into the film-cutting clearances 7; the film cutters 32 are on long strip, and one edge of each of the film cutters 32 is a corresponding one of the transverse edges 321, and blades 33 are arranged on side edges of the film cutters 32, wherein the blades 33 are vertical to side surfaces of the film cutters 32, and upper parts of the blades 33 are bulging at a sharp angle away from the film cutters 32, and the edges of the blades 33 away from the film cutters 32 are on arc-shaped and the distance of the edge of arcs to the film cutters 32 are getting smaller from top to bottom; whereby when another edge of each of two of the film cutters 32 within the coating areas 15 of the same one is abutted against each other, side surfaces of two of the blades 33 are sticking to each other, and the longitudinal edges 331 are formed by edge sticking of the arcs on two of the blades 33, and guide portions 34 on plate shaped are vertically arranged on upper parts of the side surfaces of the film cutters 32, wherein the guide portions 34 are fixedly connected with upper side surfaces of the blades 33, wherein guide rims 341 is arranged in the guide portions 34, wherein one end of each of the guide rims 341 extends into sharp corners of the blades 33 and another end of each of the guide rims 341 extends into each of the transverse edges 321 on corresponding one of the film cutters 32; whereby when edges of two of the film cutters 32 are abutted against each other, two of the blades 33 are sticking to each other and form the longitudinal edges 331, and when the rotation pipe 2 rotates, the sharp corners of the blades 33 is able to insert into and pass through the protective film under an action of the longitudinal edges 331, and then the guide rims 341 can push away the protective film from two sides until the film cutters 32 pass through the protective film, which can avoid the film cutters 32 hooking the protective film.

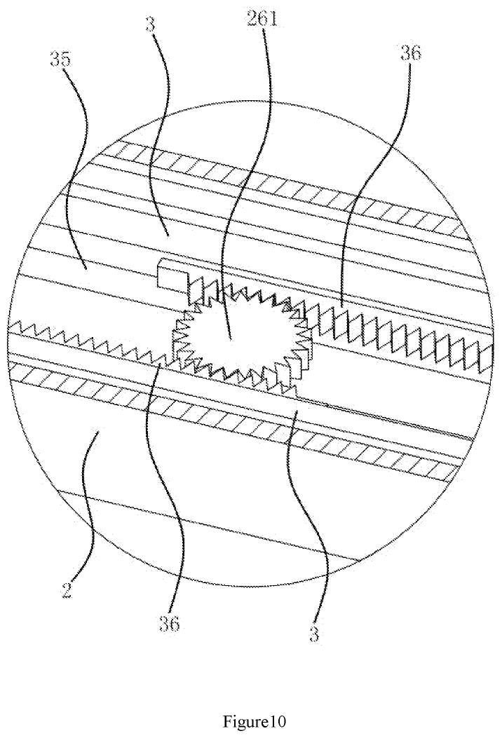

Referring to FIGS. 9 and 10, the driving member comprises a driven air cylinder 4, a driven rod 41 is slidably and horizontally connected on the frame 1, wherein a piston rod of the driven air cylinder 4 is fixedly connected with one end of the driven rod 41, wherein two of push pins 411 which are protrudes along a radial direction are arranged on outer circumference end of another end of the driven rod 41, wherein two of the push pins 411 are arranged with a same axis, and two of transmission grooves 23 on long strip are defined on side walls of one end of the rotation pipe 2 along the axis, and the transmission grooves 23 are spirally arranged along a circumference of the rotation shaft, wherein two of the transmission grooves 23 are symmetrically arranged relative to the center line of the rotation pipe 2, and another end of the driven rod 41 extends into the rotation pipe 2, and two of the push pins 411 are slidably and respectively inserted between two of the transmission grooves 23; whereby when the push pins 411 are located on outer ends of the transmission grooves 23, the film cutters 32 is inclined and in an upward arrangement, and when the driven rod 41 drive the push pins 411 to slide to inner ends of the transmission grooves 23, the rotation pipe 2 rotate until the film cutters 32 is vertically upward, and then the driven air cylinder 4 drives the driven rod 41, and the push pins 411 on the driven rod 41 are able to eject the groove walls of the transmission grooves 23 to drive the rotation pipe 2 to rotate, and then the film cutters 32 is swing upward to pass through the protective film; an ejection rod 42 is fixed on another end of the driven rod 41 along the axial direction, wherein ends of the ejection rod 42 are opposite to one end of one of the transmission rods 3, wherein resetting springs 25 are arranged between another end of the one of the transmission rods 3 and the rotation pipe 2, wherein two of guiding grooves 24 which are arranged along the axial direction are defined on side walls of the rotation pipe 2, and two of the guiding grooves 24 are arranged symmetrically and outer ends of the guiding grooves 24 are communicated with inner ends of two of the transmission grooves 23; whereby when the film cutters 32 are vertically upward, the push pins 411 is able to slide into the guiding grooves 24, and another end of the ejection rod 42 is abutted against the end of one of the transmission rods 3, and transmission gears 261 for driving another one of the transmission rods 3 to slide reversely and synchronously when one of the transmission rods 3 slides are arranged in the rotation pipe 2; whereby when the push pins 411 ejects the groove walls of the transmission grooves 23 to drive the rotation pipe 2 to rotate, a clearance is formed between the ejection rod 42 and the transmission rods 3, and the rotation pipe 2 turn into place when the push pins 411 slide into the guiding grooves 24, at this time, the ejection rod 42 is opposite to and abutted against the end of one of the transmission rods 3, and with a further ejection of the driven air cylinder 4 to the driven rod 41, the ejection rod 42 is able to eject the transmission rods 3 to move, and then the push pins 411 slide along the guiding grooves 24; when the piston rod of the driven air cylinder 4 contracts to reset, the resetting springs 25 is able to drive the transmission rods 3 to move to reset; two pairs of limiting ledges 27 which are arranged along the axial direction are arranged on the inner circumference of the rotation pipe 2, wherein side surfaces of same one pair of the limiting ledges 27 are vertical to each other, and the outer side surfaces of the transmission rods 3 comprise one cambered surface and two flat surfaces, wherein the transmission rods 3 are slidably arranged between same one pair of the limiting ledges 27, and the cambered surfaces of the transmission rods 3 come into contact with the inner circumference of the rotation pipe 2, and two flat surfaces of the transmission rods 3 respectively come into contact with side surfaces of two of the limiting ledges 27 of the same pair, and clearances are formed between two of the transmission rods 3, and avoidance recessed shoulders 35 which are arranged on opposite side surfaces of two of the transmission rods 3 along the length direction, and connecting columns 26 is fixed in the rotation pipe 2 along the radial direction, wherein the connecting columns 26 are located between the clearances of two of the transmission rods 3, wherein the transmission gears 261 are rotatably disposed on top ends of the connecting columns 26, and transmission racks 36 are fixedly disposed within the avoidance recessed shoulders 35 of two of the transmission rods 3 along the length direction, wherein the transmission gears 261 are engaged with two of the transmission racks 36, and the transmission rods 3 are slidably coupled to the rotation pipe 2 with several surfaces, which has a high stability and ensure the stability of the film cutters 32; two of the transmission rods 3 moves reversely and synchronously through the transmission gears 261 with a compact and stable structure.

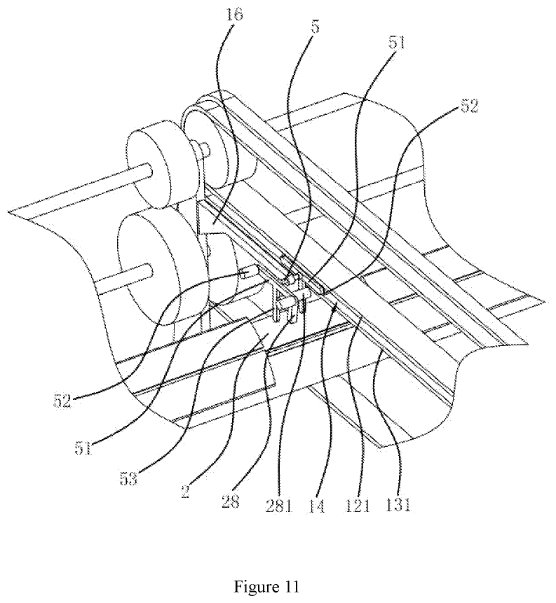

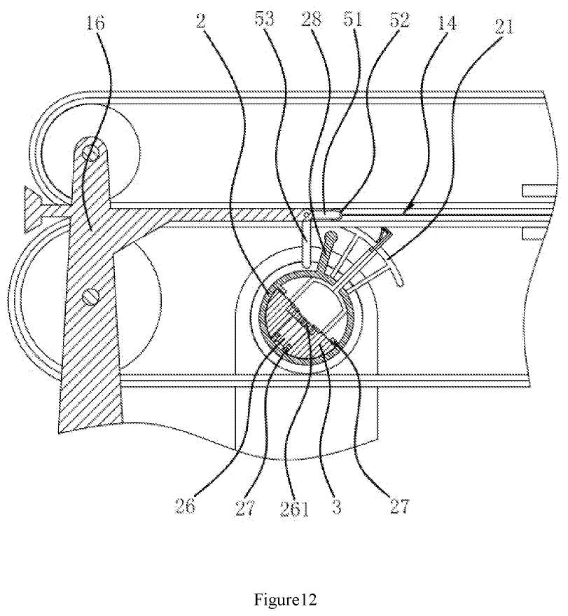

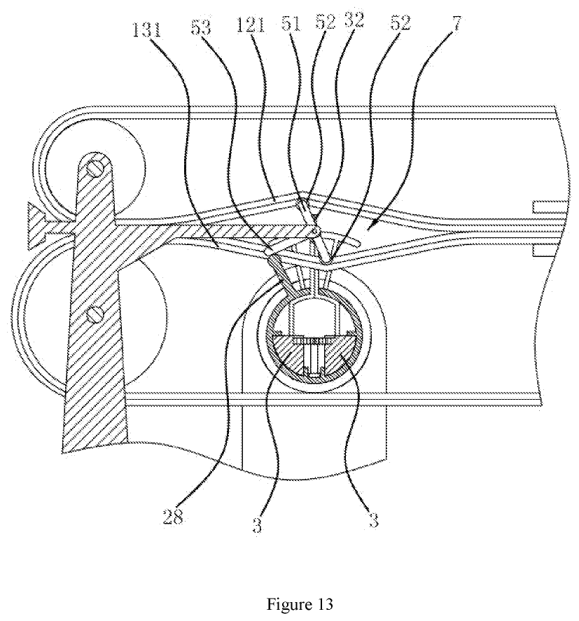

Referring to FIGS. 11, 12 and 13, the spreading element comprises the ejector wheels 52, and upper ejection flangings 121 are arranged on outer sides of the upper conveyor belts 12 along the circumference, lower ejection flangings 131 are arranged on outer sides of the lower conveyor belts 13 along the circumference, wherein ejection clearances 14 are formed between the upper ejection flangings 121 and the lower ejection flangings 131, and the transmission pins 5 are rotatably connected on outer sides of the ejection clearances 14 by the frame 1, wherein the transmission pins 5 are rotatably connected on the struts 16, and the transmission pins 5 are arranged along the horizontal direction, wherein each of the supporting rods 51 are vertically fixed on one end of each of the ejection clearances 14 of the transmission pins 5, wherein the ejector wheels 52 are rotatably connected with two ends of the supporting rods 51, and the ejector wheels 52 on two ends of the swing rods 53 are symmetrically arranged with the transmission pins 5, and two of the ejector wheels 52 inserts into the ejection clearances 14, and two of the ejector wheels 52 are on same one horizontal plane when the film cutters 32 incline upwardly, and pushing rods 28 for driving the transmission pins 5 to rotate when the rotation pipe 2 rotate are arranged on the outer circumference of the rotation pipe 2; whereby when the upper conveyor belts 12 and the lower conveyor belts 13 pull out the protective film and not begin to cut the protective film, the supporting rods 51 are in a horizontal position, and two of the ejector wheels 52 are located in the ejection clearances 14, and when the rotation pipe 2 rotates to drive the transmission pins 5 to rotate through the pushing rods 28, the transmission pins 5 drive the supporting rods 51 to swing, so that a height difference will be formed between two of the ejector wheels 52, that is to say, two of the ejector wheels 52 are able to eject the upper ejection flangings 121 and the lower ejection flangings 131 respectively to spread the upper conveyor belts 12 and the lower conveyor belts 13 to form the film-cutting clearances 7, so that the part of the protective film clamped by the upper conveyor belts 12 and the lower conveyor belts 13 can be cut; the swing rods 53 are fixedly and vertically disposed on the transmission pins 5, and the swing rods 53 are vertically downward when the supporting rods 51 is on horizontal position, and one end of the pushing rods 28 is vertically connected with ejection columns 281, wherein the ejection columns 281 is located at a side part of each of the swing rods 53, and a vertical dimension between a center line of the ejection columns 281 and a center line of the rotation pipe 2 is larger than the vertical dimension between the center line of the ejection columns 281 and a center line of the transmission pins 5, and the rotation pipe 2 rotate to drive the pushing rods 28 to swing, and then the ejection columns 281 on the pushing rods 28 is able to eject the ejector wheels 52 to drive the transmission pins 5 to rotate.

1. A film-cutting device of an environmental coating machine comprising:
a frame;
a positioning roller for locating the protective film rollers arranged on the frame;
several pairs of upper conveyor belts and lower conveyor belts,
wherein several pairs of the upper conveyor belts and the lower conveyor belts are corresponded with each other, and a lower side surface of each of the upper conveyor belts is pressed against an upper side surface of the lower conveyor belts,
wherein the upper conveyor belts and the lower conveyor belts can clamp and pull out the protective film on the positioning roller along a lengthways, and coating areas formed between two of the upper conveyor belts of the same pair, and the film-cutting machine comprises a rotation pipe arranged horizontally and rotatably connected on the frame,
cutters for cutting the protective film along a pulling direction arranged between two pairs of the upper conveyor belts by the frame,
wherein the cutters are located between the positioning roller and the rotation pipe, and two of transmission rods are slidably disposed within the rotation pipe along the length direction,
wherein several of film cutters located on the rotation pipe are fixed on the transmission rods along the length direction, and several of the film cutters on each of the transmission rods are respectively located within several of the coating areas, and transverse edges are horizontally arranged on the film cutters, and orientations of the transverse edges of two of the film cutters within the same one of the coating areas on the transmission rods are opposite,
wherein longitudinal edges are formed when two of the film cutters within the same one of the coating areas are closing to each other, and a drive member for driving the rotation pipe to rotate to make the longitudinal edges on the film cutters to pass through the protective film upward, and a spreading element for driving an opposition part of the upper conveyor belts and the lower conveyor belts to the transverse edges to separate to form film-cutting clearances when the rotation pipe rotates are arranged on the frame;
whereby the drive member can drive two of the transmission rods to move along the orientation facing by the transverse edges corresponding one of the transverse edges and make the transverse edges to pass through the film-cutting clearances when the longitudinal edges pass through the protective film.

2. The film-cutting device of an environmental coating machine defined in claim 1, wherein a pair of supporting plates are fixed in each of the coating areas on an periphery surface of the rotation pipe,
wherein the supporting plates on long strip are arranged horizontally, and cross section of the supporting plates are on arc-shaped and several of the supporting plates have a same center line with the rotation pipe,
wherein the supporting plates of the same pair are arranged paralleled, and avoidance clearance are formed between opposite edges of the supporting plates;
avoidance notches defined on the periphery surface of the rotation pipe along the length direction;
several of connecting rods fixed on two of the transmission rods,
wherein several of the supporting plates pass through the avoidance notches, and the film cutters are fixed on free ends of the connecting rods and the film cutters pass through avoidance clearances and protrude to outer side surfaces of the supporting plates.

3. The film-cutting device of an environmental coating machine defined in claim 2, wherein the connecting rods comprise radial segments and axial segments,
wherein the radial segments is on Z-shaped and one end of each of the radial segments is fixedly and vertically connected with the transmission rods, and another end of each of the radial segments passes through the avoidance notches of the rotation pipe,
wherein guide surfaces on arc-shaped are arranged on middle of the radial segments,
wherein the guide surfaces stick to an inner circumference of the rotation pipe, and the axial segments is arranged horizontally, and one end of each of the axial segments is fixedly and vertically connected with protruding end of each of the radial segments, and each of the film cutters is fixed on another end of each of the axial segments, and the orientation of another end of each of the axial segments is the same as the orientation of the transverse edges on the film cutters, and each of support portions which is protruding is arranged on another end of each of the axial segments, and the orientation of the transverse edges is the same as a protruding direction of the support portions,
wherein the support portions is located within the supporting plates;
whereby when the drive member drives the transmission rods to move, the axial segments is able to extend into the film-cutting clearances.

4. The film-cutting device of an environmental coating machine defined in claim 3, wherein the film cutters are on long strip, and one edge of each of the film cutters is a corresponding one of the transverse edges;
blades arranged on side edges of the film cutters,
wherein the blades are vertical to side surfaces of the film cutters, and upper parts of the blades are bulging at a sharp angle away from the film cutters, and the edges of the blades away from the film cutters are on arc-shaped and the distance of the edge of arcs to the film cutters are getting smaller from top to bottom;
whereby when another edge of each of two of the film cutters within the coating areas of the same one is abutted against each other, side surfaces of two of the blades are sticking to each other;
longitudinal edges formed by edge sticking of the arcs on two of the blades;
guide portions which are on plate shaped vertically arranged on upper parts of the side surfaces of the film cutters,
wherein the guide portions are fixedly connected with upper side surfaces of the blades,
wherein guide rims is arranged in the guide portions,
wherein one end of each of the guide rims extends into sharp corners of the blades and another end of each of the guide rims extends into each of the transverse edges on corresponding one of the film cutters.

5. The film-cutting device of an environmental coating machine defined in claim 2 or 3 or 4, wherein the driving member comprises a driven air cylinder,
a driven rod slidably and horizontally connected on the frame,
wherein a piston rod of the driven air cylinder is fixedly connected with one end of the driven rod,
wherein two of push pins which are protrudes along a radial direction are arranged on outer circumference end of another end of the driven rod,
wherein two of the push pins are arranged with a same axis, and two of transmission grooves on long strip are defined on side walls of one end of the rotation pipe along the axis;
transmission grooves spirally arranged along a circumference of the rotation shaft,
wherein two of the transmission grooves are symmetrically arranged relative to the center line of the rotation pipe, and another end of the driven rod extends into the rotation pipe, and two of the push pins are slidably and respectively inserted between two of the transmission grooves;
whereby when the push pins are located on outer ends of the transmission grooves, the film cutters is inclined and in an upward arrangement, and when the driven rod drive the push pins to slide to inner ends of the transmission grooves, the rotation pipe rotate until the film cutters is vertically upward.

6. The film-cutting device of an environmental coating machine defined in claim 5, wherein an ejection rod is fixed on another end of the driven rod along the axial direction,
wherein ends of the ejection rod are opposite to one end of one of the transmission rods,
wherein resetting springs are arranged between another end of the one of the transmission rods and the rotation pipe,
wherein two of guiding grooves which are arranged along the axial direction are defined on side walls of the rotation pipe, and two of the guiding grooves are arranged symmetrically and outer ends of the guiding grooves are communicated with inner ends of two of the transmission grooves;
whereby when the film cutters are vertically upward, the push pins is able to slide into the guiding grooves, and another end of the ejection rod is abutted against the end of one of the transmission rods, and transmission gears for driving another one of the transmission rods to slide reversely and synchronously when one of the transmission rods slides are arranged in the rotation pipe.

7. The film-cutting device of an environmental coating machine defined in claim 6, wherein two pairs of limiting ledges which are arranged along the axial direction are arranged on the inner circumference of the rotation pipe,
wherein side surfaces of same one pair of the limiting ledges are vertical to each other, and the outer side surfaces of the transmission rods comprise one cambered surface and two flat surfaces,
wherein the transmission rods are slidably arranged between same one pair of the limiting ledges, and the cambered surfaces of the transmission rods come into contact with the inner circumference of the rotation pipe, and two flat surfaces of the transmission rods respectively come into contact with side surfaces of two of the limiting ledges of the same pair, and clearances are formed between two of the transmission rods;
avoidance recessed shoulders arranged on opposite side surfaces of two of the transmission rods along the length direction;
connecting columns fixed in the rotation pipe along the radial direction,
wherein the connecting columns are located between the clearances of two of the transmission rods,
wherein the transmission gears are rotatably disposed on top ends of the connecting columns, and transmission racks are fixedly disposed within the avoidance recessed shoulders of two of the transmission rods along the length direction,
wherein the transmission gears are engaged with two of the transmission racks.

8. The film-cutting device of an environmental coating machine defined in claim 2 or 3 or 4, wherein the spreading element comprises the ejector wheels, and upper ejection flangings are arranged on outer sides of the upper conveyor belts along the circumference, lower ejection flangings are arranged on outer sides of the lower conveyor belts along the circumference,
wherein ejection clearances are formed between the upper ejection flangings and the lower ejection flangings, and the transmission pins are rotatably connected on outer sides of the ejection clearances by the frame,
wherein the transmission pins are rotatably connected on the struts, and the transmission pins are arranged along the horizontal direction,
wherein each of the supporting rods are vertically fixed on one end of each of the ejection clearances of the transmission pins,
wherein the ejector wheels are rotatably connected with two ends of the supporting rods, and the ejector wheels on two ends of the swing rods are symmetrically arranged with the transmission pins, and two of the ejector wheels inserts into the ejection clearances, and two of the ejector wheels are on same one horizontal plane when the film cutters incline upwardly, and pushing rods for driving the transmission pins to rotate when the rotation pipe rotate are arranged on the outer circumference of the rotation pipe.

9. The film-cutting device of an environmental coating machine defined in claim 8, wherein the swing rods are fixedly and vertically disposed on the transmission pins, and the swing rods are vertically downward when the supporting rods is on horizontal position, and one end of the pushing rods is vertically connected with ejection columns,
wherein the ejection columns is located at a side part of the swing rods, and a vertical dimension between a center line of the ejection columns and a center line of the rotation pipe is larger than the vertical dimension between the center line of the ejection columns and a center line of the transmission pins.

10. The film-cutting device of an environmental coating machine defined in claim 9, wherein the frame comprises two rows of struts vertically arranged,
wherein upper transfer rollers and lower transfer rollers are rotatably arranged on the struts,
wherein the upper conveyor belts are sleeved on corresponding two of the upper transfer rollers and the lower transfer rollers;
lower conveyor belts sleeved on corresponding two of the lower transfer rollers;
upper transfer rollers on same row fixed connected with each other by an upper rotation shaft, wherein the lower transfer rollers on same row are fixedly connected with each other by a lower rotation shaft, and the lower transfer rollers are driven to rotate by the driven motor,
wherein the transmission pins are rotatably connected on the struts,
wherein the cutters on a long strip are vertically and fixedly connected on the struts, and edges of the cutters facing to the positioning roller are cutting edges.
